(19) United States
(12) Patent Application Publication
(10) Pub. No.: US 2024/0242181 A1
(43) Pub. Date: Jul. 18, 2024

(54) DIGITAL PLATFORM FOR AI-DRIVEN SKILLS ENHANCEMENT

(71) Applicant: MySureStart, Inc., New York, NY (US)

(72) Inventor: Taniya Mishra, New York, NY (US)

(73) Assignee: MySureStart, Inc., New York, NY (US)

(21) Appl. No.: 18/621,170

(22) Filed: Mar. 29, 2024

Related U.S. Application Data
(63) Continuation-in-part of application No. 17/500,022, filed on Oct. 13, 2021, now abandoned.
(60) Provisional application No. 63/455,593, filed on Mar. 30, 2023.
(60) Provisional application No. 63/090,733, filed on Oct. 13, 2020.

(51) Int. Cl. G06Q 10/1053; G06Q 50/00; G08B 21/24; H04L 51/02

(52) U.S. Cl. CPC G06Q 10/1053; G06Q 50/01; G08B 21/24; H04L 51/02

(57) ABSTRACT

Disclosed embodiments provide techniques for a digital platform for AI-driven skills enhancement. A digital platform, enabling enhancement of one or more career skills and including an onboarding chatbot, is provided. The onboarding chatbot generates a discovery question that solicits career information from a user. The career information from the user is processed using a machine learning model running on the digital platform. The processing of the career information is used to generate one or more additional discovery questions for the user. The processed career information is used to develop a recommended career path and one or more related skills, which together comprise a career passport. The career passport includes information on vocation, mission, and passions of the user. The processing of career information is further used to recommend career-related improvement actions to the user to enhance the related skills.

### RELATED APPLICATIONS

This application claims the benefit of U.S. provisional patent application “Digital Platform For AI-Driven Skills Enhancement” Ser. No. 63/455,593, filed Mar. 30, 2023.

This application is also a continuation-in-part of U.S. patent application “Digital Platform for Proxy Mentor/Mentee Communication” Ser. No. 17/500,022, filed Oct. 13, 2021, which claims the benefit of U.S. provisional patent application “Digital Platform for Proxy Mentor/Mentee Communication” Ser. No. 63/090,733, filed Oct. 13, 2020.

Each of the foregoing applications is hereby incorporated by reference in its entirety.

### FIELD OF ART

This application relates generally to career skills enhancement and more particularly to a digital platform for AI-driven skills enhancement.

### BACKGROUND

Humans have lived and worked together in groups for many thousands of years. In many cultures, groups of people have been drawn together based on the work that they perform. People with similar jobs have congregated in unions, guilds, and other organizations.

Larger organizations such as corporations, towns, and governments have sought out diverse groups of workers to take on multiple projects, both large and small. Diversity and expertise are both valued as workers team up to accomplish a variety of tasks. In some cultures, a person's value to the community can be based on the work they do. Early in many getting-to-know-you conversations comes the question, “What do you do for a living?” The value of a person's occupation can be reflected in the size of their paychecks and in their status within the culture.

The world of work has changed significantly over time. Earlier in our history, humans lived in hunter-gatherer groups. Basic survival was the primary focus of these groups of workers. Physical strength, stamina, and dexterity were at a premium. Over time, simple tools extended man's ability to hunt, build, and begin to cultivate crops. Work began to shift to agriculture. Animals were domesticated as well as hunted. Permanent shelters were built and communities formed. As civilizations progressed and diversified, the number of hours spent on basic survival diminished. Craftmanship, blacksmiths, and trade developed, allowing humans to specialize and diversify in creating goods and exchanging products and services with one another. In the later 18^{th} and 19^{th} centuries, the Industrial Revolution led to factories, machinery, and mass production, which altered the way in which work was done, and broadened the possibilities of who could do work. Labor unions formed as workers teamed up to bargain as groups with factory owners for better pay and safer work environments. The 20^{th} century saw even more progress as technologies changed whole industries, and new ones appeared. Computers, automation processes, and robotics again changed the ways in which humans work together and interact with production systems. Telecommunication networks allowed remote work to become not only possible, but advantageous as workers from around the world could labor together to solve problems and invent new products and services.

In many modern cultures, work can be focused on tourism, art, design, exploration, and many other areas less involved with basic needs such as food and shelter, and more concerned with cultural or personal enrichment. Many economies have shifted from manufacturing to services. Employment as teachers, doctors, bankers, and information technology have become commonplace and function as essential parts of modern society. Technology advancements have increased the individual's ability to accomplish work efforts more efficiently. Automation in many forms has vastly increased the output and variety of work efforts in today's factories, offices, and schools. Global telecommunications now allow businesses to outsource people and processes from all over the world. Improvements in digital communications will continue to reshape the ways in which people collaborate with one another. As it has throughout history, changes in the work world will continue to impact the way in which we work, play, and value one another.

### SUMMARY

Finding one's place in the world of work can be an intimidating and difficult process. Our education systems can be helpful, but not necessarily decisive, in choosing a career path. Many young people approach the end of their formal education without a clear direction of how to find a job that they can learn to do well and enjoy. Older workers can have similar challenges when they change jobs, whether the change is voluntary or a result of layoffs, workplace closings, or for other reasons. Many experts in the field of human resources and career placement emphasize collaborating with others as a necessary part of the search for a great job. Technology has increasingly provided ways of connecting and joining forces with others in many areas, including choosing and pursuing a career. Digital environments including metaverse interfaces and intelligent chatbots can allow users to interact with one another, peers, employers, recruiters, and artificial intelligence (AI) systems to select a career path and hone the skills necessary to pursue it.

Disclosed embodiments provide techniques for a digital platform for AI-driven skills enhancement. A digital platform, enabling enhancement of one or more career skills and including an onboarding chatbot, is provided. The onboarding chatbot generates a discovery question that solicits career information from a user. The career information from the user is processed using a machine learning model running on the digital platform. The processing of the career information is used to generate one or more additional discovery questions for the user. The processed career information is used to develop a recommended career path and one or more related skills, which together comprise a career passport. The career passport includes information on vocation, mission, and passions of the user. The processing of career information is further used to recommend career-related improvement actions to the user to enhance the related skills.

A computer-implemented method for career skills enhancement is disclosed comprising: providing a digital platform that enables enhancement of one or more career skills, wherein the digital platform includes an onboarding chatbot; generating a discovery question, by the onboarding chatbot, wherein the discovery question solicits career information from a user; processing the career information from the user, wherein the processing generates one or more further discovery questions for the user, and wherein the processing is based on a machine learning model running on the digital platform; developing for the user, using one or more processors, a recommended career path and one or more related skills, wherein the developing is based on the processing of the career information; and recommending career-related improvement actions to the user, by the machine learning model, to enhance the one or more related skills. In embodiments, the recommended career path and the one or more related skills comprise a career passport. In embodiments, the career passport includes information on vocation, mission, and passions of the user. In embodiments, the recommending further comprises establishing a goal, for the user, wherein the goal enhances the one or more related skills. Some embodiments comprise connecting the user to friends, peers, mentors, or employers, wherein the connecting is based on the career passport. In embodiments, the career passport is included in a recruiter database. Some embodiments comprise presenting the career passport to the user. In embodiments, the discovery question and information from the user are communicated using natural language processing (NLP).

Various features, aspects, and advantages of various embodiments will become more apparent from the following further description.

### BRIEF DESCRIPTION OF THE DRAWINGS

The following detailed description of certain embodiments may be understood by reference to the following figures wherein:

FIG. 1 is a flow diagram of a digital platform for AI-driven skills enhancement.

FIG. 2 is a flow diagram for enabling improvement actions.

FIG. 3 is an infographic for onboarding.

FIG. 4 is an infographic for enhancing skills with a countdown timer.

FIG. 5 is an infographic for enhancing skills with an email reminder.

FIG. 6 is an example of a career passport created on the digital platform.

FIG. 7 is a block diagram of a digital platform.

FIG. 8 is a flow diagram for machine learning.

FIG. 9 is a system diagram of AI-driven skills enhancement.

### DETAILED DESCRIPTION

Selecting a career path can be a challenging and intimidating endeavor. Gathering information on the skills required to perform a job well; understanding the work environments; and matching personal aspirations, abilities, and limitations to the career options available can require many hours of effort. Disclosed embodiments address the issues of matching personal career information to career paths and their related skill sets. The interaction between the user and career paths is provided using a digital platform including an artificial intelligence (AI) neural network. A conversational chatbot and metaverse environment are part of the digital platform, allowing the user to interact with other job seekers as well as job providers. Enabled by a machine learning system, the digital platform can provide recommendations on career paths and related skill sets, as well as a virtual community to provide encouragement and expertise as the user pursues career options. The complexities and nearly infinite variations of career paths and related skill sets necessitate a machine learning approach for deployment in a scalable environment. A scalable environment is required to meet needs across a broad swath of the socioeconomic spectrum and to provide career passports in an equitable fashion.

Techniques for career skills enhancement are disclosed. A digital platform that enables the enhancement of one or more skills related to a career path can be provided. The user interaction with the digital platform can be delivered through a conversational chatbot linked to an AI machine learning model. The machine learning model can generate discovery questions that elicit career information from the user. The chatbot interaction uses natural language processing (NLP) so that the conversations between the user and the machine learning model feel natural. After sufficient career information has been collected from the user and processed by the machine learning model, recommendations regarding a career path and related skills are provided for the user. The recommendations can include images that highlight recommended career paths and skills selected by the AI machine learning model. The career information and recommendations can be assembled into a career passport. The career passport can be used to summarize the intentions, aspirations, and motivations of the user regarding a particular career path. The career passport can also be used to generate goals for the user to improve their performance of the skills necessary to secure the career they pursue.

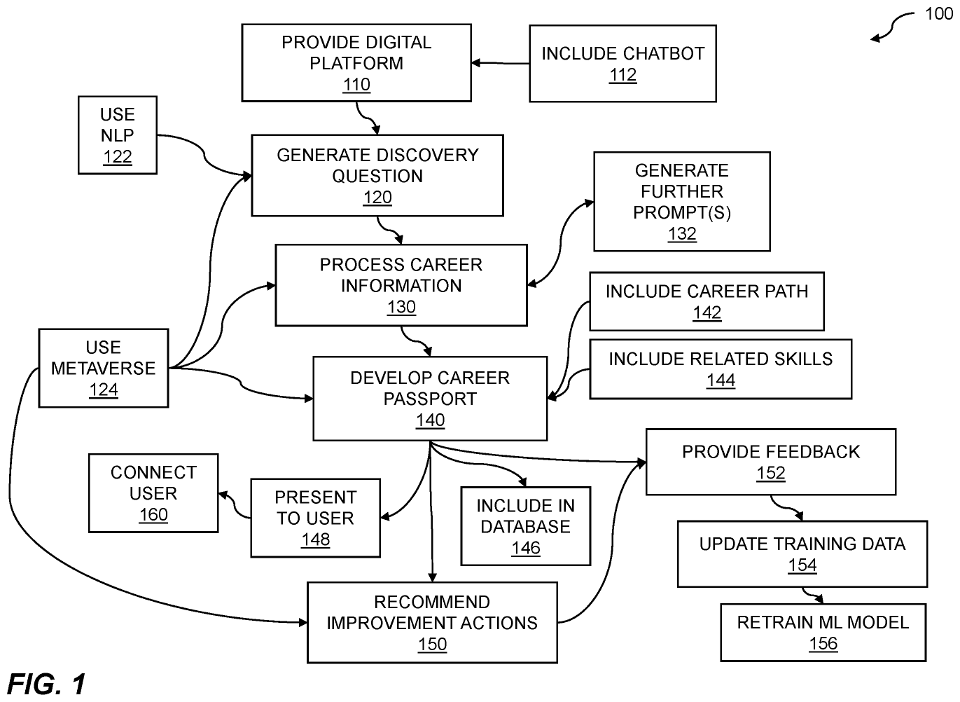

FIG. 1 is a flow diagram of a digital platform for AI-driven skills enhancement. The digital platform enables enhancement of one or more career skills and includes an onboarding chatbot. The onboarding chatbot generates a discovery question that solicits career information from a user. The career information from the user is processed using a machine learning model and is used to generate one or more additional discovery questions for the user. The processed career information is used to develop a recommended career path and one or more related skills, which together comprise a career passport. The flow 100 includes providing a digital platform 110 that enables enhancement of one or more career skills, wherein the digital platform includes an onboarding chatbot 112. A digital platform is a group of computer-based applications that work together to form a virtual work and communications environment for users. In embodiments, a data-ingestion engine, a machine-learning transactional engine to perform tasks or rules-based activities, an analytical engine, an AI engine, APIs, and tools that allow the digital platform to interact with other software can all be components of a digital platform. In some embodiments, tools to monitor regulatory compliance can be included as well. The digital platform can be presented to users with HTML or other browser-friendly languages. The digital platform can be accessed using a mobile device, pad, tablet, laptop computer, or desktop computer. In some embodiments, a separate application can be used to access a digital platform.

The flow 100 includes a chatbot 112 to interact with a digital platform user. A chatbot is an artificial intelligence (AI) driven messaging application that simulates human conversation through voice commands, text chats, or both. In embodiments, the chatbot uses a neural network that allows human-like interactions with users. A neural network is a form of AI that mimics the human nervous system. Algorithms in a neural network can be used to recognize patterns and correlations in raw data, such as verbal or text input, can cluster and classify it, and over time can learn and improve in its responses to new data input. The chatbot program learns as it interacts with users, expanding its vocabulary and accuracy in responding to users as it goes. In embodiments, the chatbot is initiated by a user action on the digital platform, such as signing onto the digital platform. In some embodiments, the chatbot is started after a user signs into the digital platform for the first time and enters basic information, such as a username, email address, etc.

The flow 100 includes generating a discovery question 120, by the onboarding chatbot, wherein the discovery question solicits career information from a user. In embodiments, the discovery question relates to the personality, technical skills, preferences, or career aspirations of the user, for example, “What 3 things would you rather be doing?” The chatbot discovery question and the response from the user are communicated using natural language processing (NLP) 122. Natural language processing is a form of artificial intelligence (AI) that uses machine learning to process and interpret text and data. There can be multiple stages in NLP, including language recognition; language generation; language understanding to categorize, archive, and analyze text to determine meaning; and in some embodiments, decision-making based on the meaning of the text. In embodiments, the chatbot linked to the NLP machine learning engine is a conversational chatbot assistant. Conversational AI chatbot assistants are linked to the neural network to understand a wide range of ways in which a user can respond to a question. They learn from each user interaction and can be taught to understand spelling mistakes, shortened words, and acronyms. Historical data can be easily bootstrapped to the NLP machine learning engine so that it learns more quickly. The conversational AI chatbot assistant allows the user to carry on a more human interaction, with the chatbot, that improves over time. In some embodiments, the chatbot NLP can include a virtual drop-down system, showing the user possible response options to discovery questions, such as “coding”, “teaching”, and “reading”.

The flow 100 includes the generating of a discovery question using a metaverse environment 124. A metaverse is a shared, collective virtual environment that people access via the Internet. The metaverse environment 124 employs virtual reality and avatars to create a sense of virtual presence within the environment. The metaverse environment can include virtual twins of objects, people, spaces, environments, and so on. Users can interact with computer-generated environments, objects, and other users' avatars within the metaverse environment. An avatar is a graphical representation of a user within the metaverse virtual environment. In embodiments, a metaverse environment 124 can be accessed by the digital platform users, employers, friends, peers, mentors, and recruiters to interact with one another. Conversations between participants can be captured and analyzed by the NLP machine learning engine. Questions and comments made by participants can be used to develop and refine discovery questions and to interpret responses from users. In embodiments, the metaverse environment can be used in multiple stages in the flow, including processing career information, developing a career passport, and recommending improvement actions to the user.

The flow 100 includes processing career information 130 from the user, wherein the processing generates one or more further discovery questions 132 for the user, and wherein the processing is based on a machine learning model running on the digital platform. In embodiments, the user response to the discovery question 120 can be analyzed by the machine learning model within the digital platform 110. The career information processing 130 can include comparing the user response to those of other users and to categories of responses linked to particular skills, career paths, and goals that are part of the machine learning model. Based on the user response to the discovery question 120, additional discovery questions 132 can be posed to the user via the chatbot. The additional discovery questions can relate to the personality, technical skills, preferences, or career aspirations of the user. In some embodiments, the machine learning neural network can select images that illustrate and promote career paths and related skills based on the user's responses. In embodiments, each user response to additional discovery questions can be recorded and used to generate additional discovery questions and to develop a profile of the user, including skills, career interests and aspirations, education, experience, etc., leading to the development of a career passport 140.

The flow 100 includes developing for the user, using one or more processors, a recommended career path 142 and one or more related skills 144, wherein the developing is based on the processing of the career information 130. In embodiments, the career information collected from the user can be processed by the machine learning neural network and used to select career paths 142 and related skills 144 that correspond with the user's responses. The recommended career path 142 and the one or more related skills 144 comprise a career passport 140. The career passport includes information on vocation, mission, and passions of the user based on their responses to discovery questions 120 and to career path images selected by the machine learning neural network. It can be used to summarize the user's direction, focus, and career goals; connect with other users with similar interests; and inform future improvement actions. As mentioned above and throughout, the development of the career passport can be linked to a metaverse environment 124 that can be accessed by users and others to interact with one another. Comments made by participants can be used by the machine learning engine to develop and refine the career passport 140. Once the career passport is assembled, it is presented to the user 148. In some embodiments, the user can be connected 160 to friends, peers, mentors, or employers using the digital platform, based on the career passport. The career passport can also be included in a recruiter database 146.

The flow 100 includes recommending career-related improvement actions 150 to the user, by the machine learning model, to enhance the one or more related skills 144. In embodiments, the related skills 144 included in the career passport 140 are based on machine learning models of career paths 142 and skills required to succeed in the career paths. The recommended actions 150 are based on one or more related skills that are current deficiencies for the user. For example, the digital platform chatbot might say, “I'd recommend coding for 20 minutes. Sound good?” to a user that wants to become an application developer. In embodiments, the recommendations further involve establishing a goal for the user, wherein the goal enhances the one or more related skills. The goal can be represented as part of a digital vision board. A digital vision board is a virtual bulletin board that contains pictures of items that represent a future career or business. It is a type of wish list, allowing the user to visualize who or what they want to be in the future. The images can be selected by the machine learning model and displayed to the user or selected by the user from other sources. The digital vision board can be displayed and edited by the user on the digital platform.

In embodiments, the recommended improvement actions 150 can include reminding the user to complete a goal using one or more alerts. The alerts can include an alarm or countdown timer based on a timeline associated with the one or more related skills. The alarm or countdown timer can appear in the chatbot window as the user interacts with the digital platform. The alerts can include email notices sent to the user with reminders to complete goals related to particular skills. In some embodiments, the email can include a hypertext link to the digital platform. In embodiments, the digital platform can include the ability for the user to change the timing and method of the alerts. The improvement action process 150 can include recording a history of completed items and tracking a streak of completed items related to the enhancing of the one or more related skills. A streak is a series of events or actions that have occurred consecutively over a series of days. The information related to the streak of completed items related to selected skills can be displayed on an application linked to the digital platform running on a mobile device. The streak of completed items can also be shared on a social network.

The flow 100 includes providing feedback 152 from the user, including completed skill improvement items; input from peers, mentors, employers, and recruiters; and other user interactions with the digital platform. In embodiments, feedback from conversations and interactions in the metaverse environment 124 can also be used as input to the machine learning model. The feedback 152 can be used to update the training data 154 for the machine learning module. The training data can be continually updated with feedback 152 from the digital platform and other learning models for various careers. The updated training data 154 can be used to retrain the machine learning model 156 so that it continues to improve the effectiveness of the digital platform for the users. The retrained machine learning model can improve the terminology, options, and conversation flow generated by the natural language processor chatbot. Additional career paths, related skills, discovery questions, and other career information can all be improved and expanded as feedback is provided and used to update training data which in turn can be used to retrain the machine learning model.

Various steps in the flow 100 may be changed in order, repeated, omitted, or the like without departing from the disclosed concepts. Various embodiments of the flow 100 can be included in a computer program product embodied in a non-transitory computer readable medium that includes code executable by one or more processors.

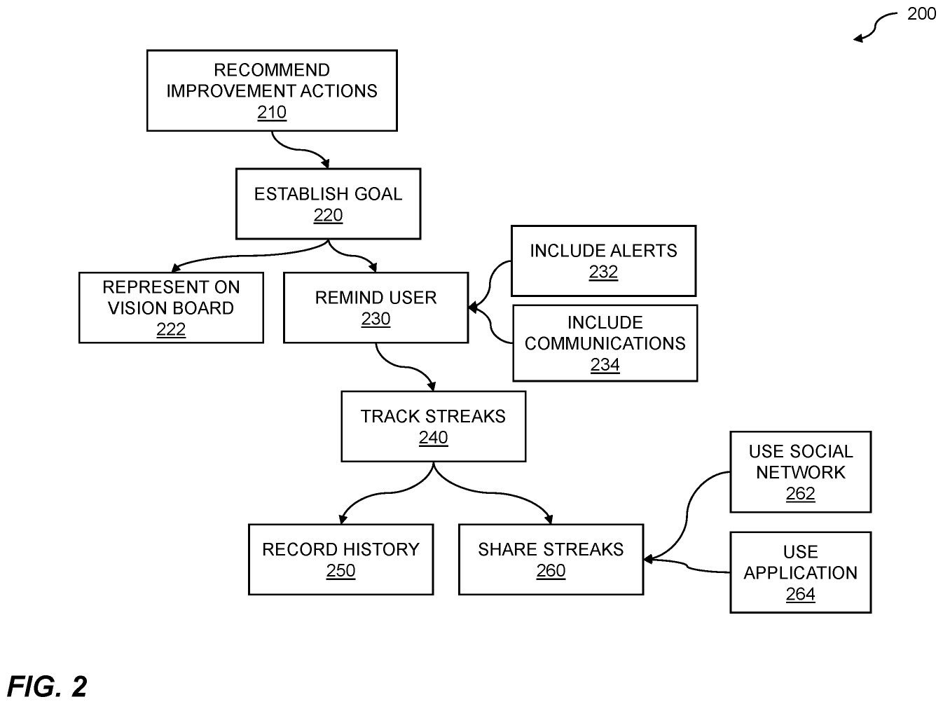

FIG. 2 is a flow diagram for enabling improvement actions. The improvement actions enable enhancement of one or more career skills and include an onboarding chatbot. The onboarding chatbot generates a discovery question that solicits career information from a user. The career information from the user is processed using a machine learning model and is used to generate one or more additional discovery questions for the user. The processed career information is used to develop a recommended career path and one or more related skills, which together comprise a career passport. The flow 200 includes recommending career-related improvement actions 210 to the user by the machine learning model running on the digital platform. In embodiments, the recommended improvement actions 210 are based on a career path and related skills suggested to the user by the machine learning model in response to information gathered from answers to discovery questions. The machine learning model can include learning models for various careers that can be used to generate the improvement actions 210. In some embodiments, the improvement actions can be put forward based on current deficiencies of the user based on the one or more skills related to a recommended career path.

The flow 200 includes establishing a goal 220 for the user to enhance one or more of the skills related to a recommended career path. In some embodiments, the goal 220 can be represented as part of a digital vision board 222. A digital vision board is a virtual bulletin board that contains pictures of items that represent a career, business, or lifestyle. It is a type of wish list, allowing the user to visualize who or what they want to be in the future. The images can be selected by the machine learning neural network and displayed to the user or selected by the user from other sources. The digital vision board can be viewed and updated by the user on the digital platform. In embodiments, the goals are short-term, daily tasks designed to improve the user's performance of skills related to a career path. As the user completes daily goals, their competence and confidence in performing significant skills can improve and their ability to pursue a chosen career path successfully can grow.

The flow 200 includes reminding the user 230 to complete the goals established to improve the skills related to their career path. In embodiments, the reminders can include alerts 232 that appear in the chatbot window, countdown timers, and other forms of communications 234, such as texts and email notices. A countdown timer or alarm can be set as a result of a chatbot interaction with the user related to a particular goal. For example, a goal of coding for 20 minutes can be established for a user who wants to be an application developer. At various times during the day, a chatbot alarm message can appear reminding the user to complete the 20-minute coding goal. When the user is ready to begin coding, a countdown timer can be placed in the chatbot window showing the time remaining as the user works on program code. When the coding goal is completed, a message of encouragement or congratulations can be generated by the chatbot, and the completed goal can be recorded as part of a record history 250. In some embodiments, communication 234 such as a text to the user's mobile phone or an email message can be generated to remind the user to complete a particular goal. The text message or email can contain a hypertext link to the digital platform. In embodiments, the user can have the ability to change the alert modes, times, frequencies, and so on.

The flow 200 includes tracking streaks 240 of goals completed by the user. In embodiments, a streak is a series of goals related to career path skills that have been completed consecutively over a series of days. The information related to the streak of completed items can be recorded in a history file 250 and/or shared 260 on the digital platform. The streak can also be displayed on an application 264 linked to the digital platform running on a mobile device or viewed by users on a social network 262. The streak can also be viewed in the metaverse environment related to the digital platform. In embodiments, the tracking 240 and sharing 260 of streaks of completed goals can be used to stimulate a user to continue to improve skills related to a career path. Similar to social media platforms and applications for improving health by changing diet or exercising, groups of users can view and encourage one another as they complete daily goals. The chatbot can be used to send messages to other users and receive positive texts from others, as well as from the machine learning model. In some embodiments, the machine learning model can use the record history 250 to monitor and find ways to improve goal completion through more effective messages and dialogues with the user.

Various steps in the flow 200 may be changed in order, repeated, omitted, or the like without departing from the disclosed concepts. Various embodiments of the flow 200 can be included in a computer program product embodied in a non-transitory computer readable medium that includes code executable by one or more processors.

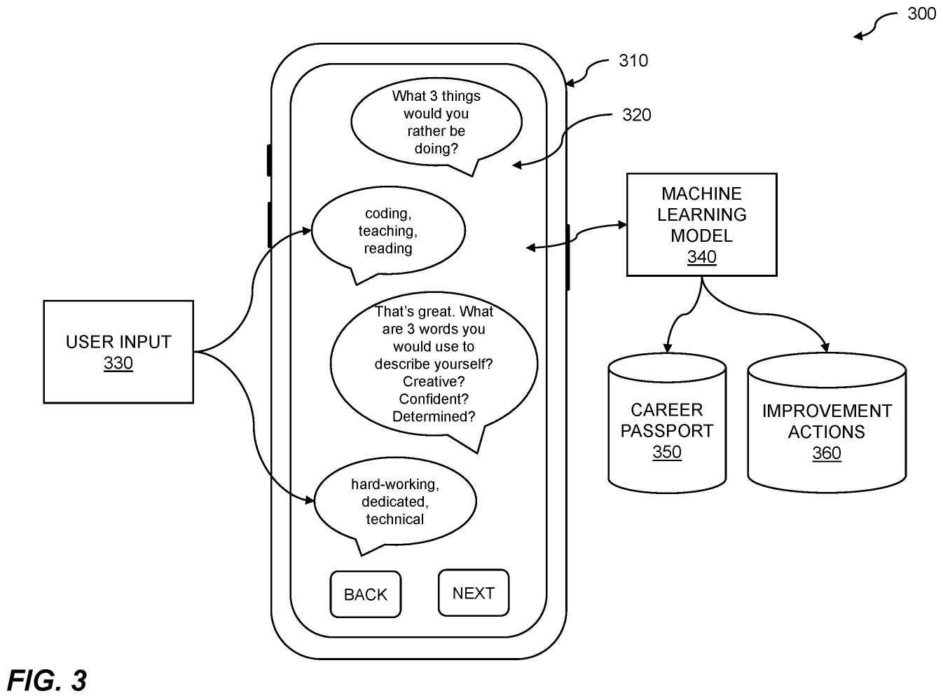

FIG. 3 is an infographic for onboarding. Onboarding enables enhancement of one or more career skills. An onboarding chatbot generates a discovery question that solicits career information from a user. The career information from the user is processed using a machine learning model and is used to generate one or more additional discovery questions for the user. The processed career information is used to develop a recommended career path and one or more related skills, which together comprise a career passport. The infographic 300 includes a device 310 that can access a digital platform which includes an onboarding chatbot 320. In embodiments, the digital platform can enable and promote the enhancement of career skills. The device 310 used to access the digital platform can be a mobile phone, pad, tablet, laptop computer, desktop computer, or another computing device capable of running a browser application and accessing the Internet. In some embodiments, the device 310 can be a virtual reality (VR) set such as a head mounted display (HMD) or other gaming system. The VR device can access a metaverse environment that is a part of the digital platform. VR devices allow a user to interact with computer-generated environments, objects, and other users' avatars within a metaverse environment. The VR devices generate a 3D display and stereo sound so that the user is immersed in a realistic virtual environment. The user can speak into a microphone linked to the VR device in order to interact with avatars of other users in the metaverse environment, or with the chatbot controlled by the machine learning model within the digital platform.

The infographic 300 includes user input 330. In embodiments, a chatbot is initiated by a user action on the digital platform, such as signing onto the digital platform for the first time and entering basic information, such as a username, email address, etc. A chatbot is an artificial intelligence (AI) driven messaging application that simulates human conversation through voice commands, text chats, or both. In embodiments, the chatbot uses a neural network, included in the digital platform machine learning model, which allows human-like interactions with users. A neural network is a form of AI that mimics the human nervous system. After the user is signed onto the digital platform and the chatbot is started, the machine learning model 340 generates a discovery question to solicit career information from the user. The discovery question is displayed for the user in the chatbot window. The user input 330 in response to the first discovery question can be processed by the machine learning model 340 running on the digital platform, leading to additional discovery questions.

In embodiments, the discovery question generated by the machine learning model relates to the personality, technical skills, preferences, or career aspirations of the user, for example, “What 3 things would you rather be doing?” The chatbot discovery question is communicated using natural language processing (NLP). Natural language processing is a form of artificial intelligence (AI) that uses machine learning to process and interpret text and data. There can be multiple stages in NLP, including language recognition; language generation; language understanding to categorize, archive, and analyze text to determine meaning; and in some embodiments, decision making based on the meaning of the text. In embodiments, the chatbot linked to the NLP machine learning engine can be a conversational chatbot assistant. Conversational AI chatbot assistants are linked to a neural network to understand a wide range of ways in which a user can respond to a question. They learn from each user interaction and can be taught to understand spelling mistakes, shortened words, and acronyms. Historical data can be easily bootstrapped to the NLP machine learning engine so that it learns more quickly. The conversational AI chatbot assistant allows the user to carry on a more human interaction, with the chatbot, that improves over time. In some embodiments, the chatbot NLP can include a virtual drop-down system, showing the user possible response options to discovery questions, such as, “Creative? Confident? Determined?”.

The infographic 300 includes the developing of a career passport 350. In embodiments, the user response 330 to the discovery question can be processed by the machine learning model 340 within the digital platform. The career information processing can include comparing the user response to those of other users and to categories of responses linked to particular skills, career paths, and goals that are part of the machine learning model. Based on the user response to the discovery question, additional discovery questions can be posed to the user via the chatbot 320. The additional discovery questions can relate to the personality, technical skills, preferences, or career aspirations of the user. In embodiments, each user response to additional discovery questions can be recorded and used to generate additional discovery questions and to develop a profile of the user, including skills, career interests and aspirations, education, experience, etc., leading to the development of a career passport 350. The career passport 350 includes information on vocation, mission, and passions of the user based on their responses to discovery questions. It can be used to summarize the user's direction, focus, and career goals; connect with other users with similar interests; and inform future improvement actions.

In some embodiments, the additional discovery questions can include images of various career paths and related skills. The images can be selected by the machine learning model based on the user's responses to discovery questions. The images can be selected from a library of images that can be analyzed by the machine learning engine. The machine learning neural network can be taught to identify objects of interest that appear in images and recognize which category of career or skill they belong to. Training data in the form of video images, scanned pictures, and photographs can be fed into a neural network algorithm. The training data can be used to create an image recognition model. As the neural network is trained with multiple images of career paths and related skills, the image recognition model can be refined to identify specific categories and classes. Once the image recognition model is built, it can be refined and expanded with additional images of various careers and skills. The result is a growing set of images that can be selected and displayed for the user based on responses to discovery questions. For example, a user with interests in biophysics, running, and helping others might be shown images of a sports medicine doctor helping a patient exercise a knee or a professor of applied physiology working with a runner on a treadmill. As users select images that most interest them, the machine learning model can refine recommendations for career paths and related skills.

As mentioned above and throughout, the development of the career passport 350 can be linked to a metaverse environment that can be accessed by users and others to interact with one another. Comments made by participants can be used by the machine learning engine to develop and refine the career passport. Once the career passport 350 is assembled, it is presented to the user. In some embodiments, the user can be connected to friends, peers, mentors, or employers using the digital platform, based on the career passport. The career passport 350 can also be included in a recruiter database.

The infographic 300 includes recommending improvement actions 360 to the user, based on the career path and related skills included in the career passport 350. In embodiments, the recommended improvement actions 360 are designed to enhance the career-related skills. The related skills included in the career passport 350 are based on machine learning models of career paths and skills required to succeed in the career paths. The recommended actions 360 are based on one or more related skills that are current deficiencies for the user. For example, the digital platform chatbot might say, “I'd recommend coding for 20 minutes. Sound good?” to a user that wants to become an application developer. In embodiments, the recommendations further involve establishing a goal for the user, wherein the goal enhances the one or more related skills. The use of goals is discussed further in the following figures. After the career passport 350 has been generated and improvement actions 360 have been recommended, the user can be fully engaged in the use of the digital platform to enhance the skills related to the career path included in the career passport. The onboarding of the user onto the digital platform has been successfully completed.

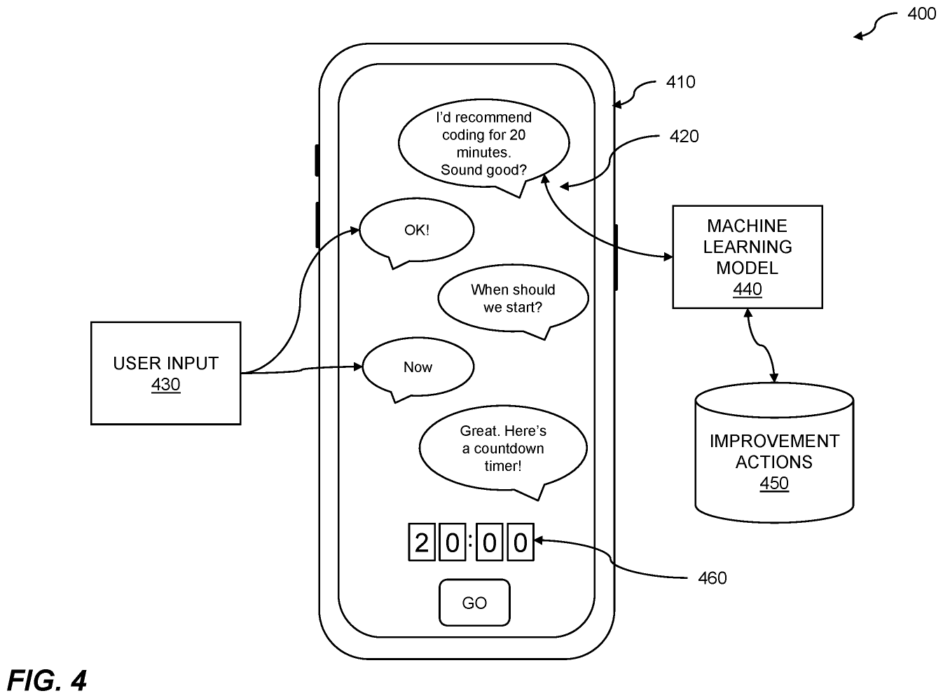

FIG. 4 is an infographic for enhancing skills with a countdown timer. The countdown timer enables enhancement of one or more career skills. An onboarding chatbot generates a discovery question that solicits career information from a user. The career information from the user is processed using a machine learning model and is used to generate one or more additional discovery questions for the user. The processed career information is used to develop a recommended career path and one or more related skills, which together comprise a career passport. The infographic 400 includes a device 410 that can access a digital platform which includes an onboarding chatbot 420. In embodiments, the digital platform can enable and promote the enhancement of career skills. The device 410 used to access the digital platform can be a mobile phone, pad, tablet, laptop computer, desktop computer, or another computing device capable of running a browser application and accessing the Internet. In some embodiments, the device 410 can be a virtual reality (VR) set such as a head mounted display (HMD) or other gaming system. The VR device can access a metaverse environment that is a part of the digital platform.

The infographic 400 includes user input 430. In embodiments, a chatbot 420 is initiated by a user action on the digital platform, such as signing onto the digital platform. The chatbot 420 uses a neural network, included in the digital platform machine learning model, which allows human-like interactions with users. After the user is signed onto the digital platform and the chatbot 420 is started, the machine learning model 440 can access the career passport developed from the user responses to discovery questions. The career passport includes information on vocation, mission, and passions of the user based on their responses to discovery questions. It can be used to summarize the user's direction, focus, and career goals; connect with other users with similar interests; and inform future improvement actions 450.

The infographic 400 includes improvement actions 450. In embodiments, the improvement actions are designed to enhance the career-path-related skills included in the career passport. The related skills are based on machine learning models of career paths and skills required to succeed in the career paths. The improvement actions are based on one or more related skills that are current deficiencies for the user. The machine learning model can use the improvement actions and the current skill deficiencies of the user to recommend a goal for the user. In embodiments, the goals are short-term, daily tasks designed to improve the user's performance of skills related to a career path. As the user completes daily goals, their competence and confidence in performing significant skills can improve and their ability to pursue a chosen career path successfully can grow. For example, the digital platform chatbot might say, “I'd recommend coding for 20 minutes. Sound good?” to a user that wants to become an application developer. In some embodiments, the goal can be represented as part of a digital vision board. A digital vision board is a virtual bulletin board that contains pictures of items that represent a career, business, or lifestyle. It is a type of wish list, allowing the user to visualize who or what they want to be in the future. The pictures can be selected by the machine learning model and displayed to the user or selected by the user from other sources. The digital vision board can be viewed and updated by the user on the digital platform.

The infographic 400 includes reminding the user to complete the goals established to improve the skills related to their career path. In embodiments, the reminders can include an alarm or countdown timer 460 that appears in the chatbot window 420. A countdown timer 460 or alarm can be set as a result of a chatbot interaction 420 with the user related to a particular goal. For example, a goal of coding for 20 minutes can be established for a user who wants to be an application developer. At various times during the day, a chatbot alarm message can appear reminding the user to complete the 20-minute coding goal. When the user is ready to begin coding, a countdown timer 460 can be placed in the chatbot window showing the time remaining as the user works on program code. When the coding goal is completed, a message of encouragement or congratulations can be generated by the chatbot, and the completed goal can be recorded as part of a record history. In some embodiments, messages such as a text to the user's mobile phone or an email message can be generated to remind the user to complete a particular goal. The text message or email can contain a hypertext link to the digital platform. In embodiments, the user can have the ability to change the alert modes, times, frequencies, and so on.

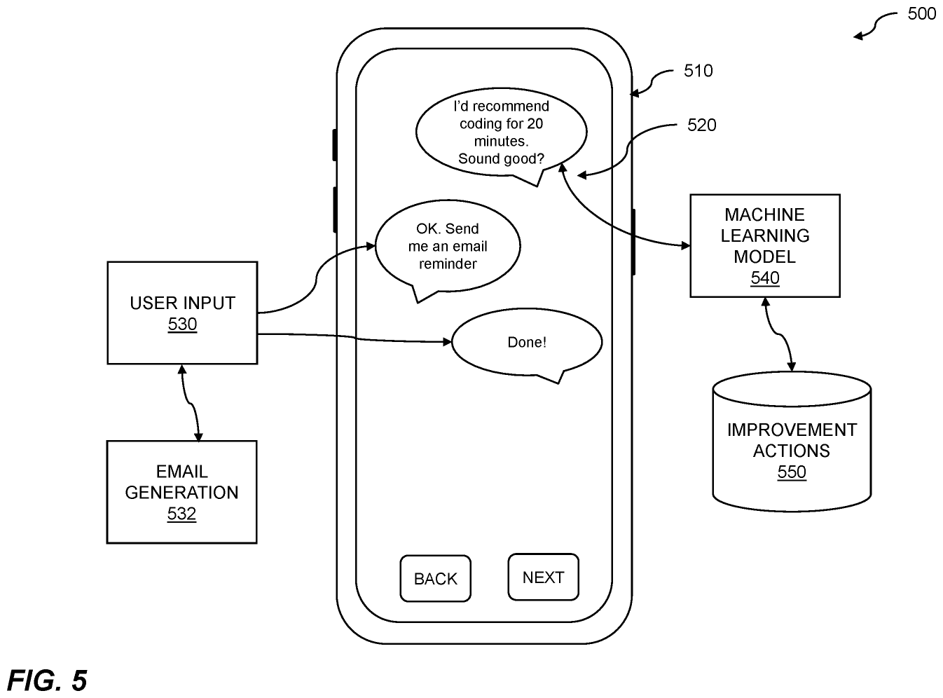

FIG. 5 is an infographic for enhancing skills with an email reminder. The email reminder enables enhancement of one or more career skills. An onboarding chatbot generates a discovery question that solicits career information from a user. The career information from the user is processed using a machine learning model and is used to generate one or more additional discovery questions for the user. The processed career information is used to develop a recommended career path and one or more related skills, which together comprise a career passport. The infographic 500 includes a device 510 that can access a digital platform which includes an onboarding chatbot 520. In embodiments, the digital platform can enable and promote the enhancement of career skills. The device 510 used to access the digital platform can be a mobile phone, pad, tablet, laptop computer, desktop computer, or another computing device capable of running a browser application and accessing the Internet. In some embodiments, the device 510 can be a virtual reality (VR) set such as a head mounted display (HMD) or other gaming system. The VR device can access a metaverse environment that is a part of the digital platform.

The infographic 500 includes user input 530. In embodiments, a chatbot 520 is initiated by a user action on the digital platform, such as signing onto the digital platform. The chatbot 520 uses a neural network, included in the digital platform machine learning model, which allows human-like interactions with users. After the user is signed onto the digital platform and the chatbot 520 is started, the machine learning model 540 can access the career passport developed from the user responses to discovery questions. The career passport includes information on vocation, mission, and passions of the user based on their responses to discovery questions. It can be used to summarize the user's direction, focus, and career goals; connect with other users with similar interests; and inform future improvement actions 550.

The infographic 500 includes improvement actions 550. In embodiments, the improvement actions are designed to enhance the career-path-related skills included in the career passport. The related skills are based on machine learning models of career paths and skills required to succeed in the career paths. The improvement actions are based on one or more related skills that are current deficiencies for the user. The machine learning model can use the improvement actions and the current skill deficiencies of the user to recommend a goal for the user. In embodiments, the goals are short-term, daily tasks designed to improve the user's performance of skills related to a career path. As the user completes daily goals, their competence and confidence in performing significant skills can improve and their ability to pursue a chosen career path successfully can grow. For example, the digital platform chatbot might say, “I'd recommend coding for 20 minutes. Sound good?” to a user that wants to become an application developer. In some embodiments, the goal can be represented as part of a digital vision board. A digital vision board is a virtual bulletin board that contains pictures of items that represent a career, business, or lifestyle. It is a type of wish list, allowing the user to visualize who or what they want to be in the future. The pictures can be selected by the machine learning model and displayed to the user or selected by the user from other sources. The digital vision board can be viewed and updated by the user on the digital platform.

The infographic 500 includes reminding the user to complete the goals based on improvement actions 550 recommended by the machine learning model 540. In embodiments, the reminders can include messages such as a text to the user's mobile phone or an email message 532 to remind the user to complete a particular goal. The text message or email can contain a hypertext link to the digital platform. For example, a goal of coding for 20 minutes can be established for a user who wants to be an application developer, based on an improvement action 550 recommended by the machine learning model 540. The user can input a request for an email reminder related to the 20-minute coding goal during a chatbot interaction 520 with the machine learning model 540. The machine learning model 540 can process the user input 530 and generate an email 532 to the user with a reminder to complete the 20-minute coding goal. In embodiments, the reminders can include an alarm. At various times during the day, the alarm can be used to generate an additional email related to the improvement goal. When the coding goal is completed, a message of encouragement or congratulations can be generated by the chatbot, and the completed goal can be recorded as part of a record history. In embodiments, the user can have the ability to change the alert modes, times, frequencies, and so on.

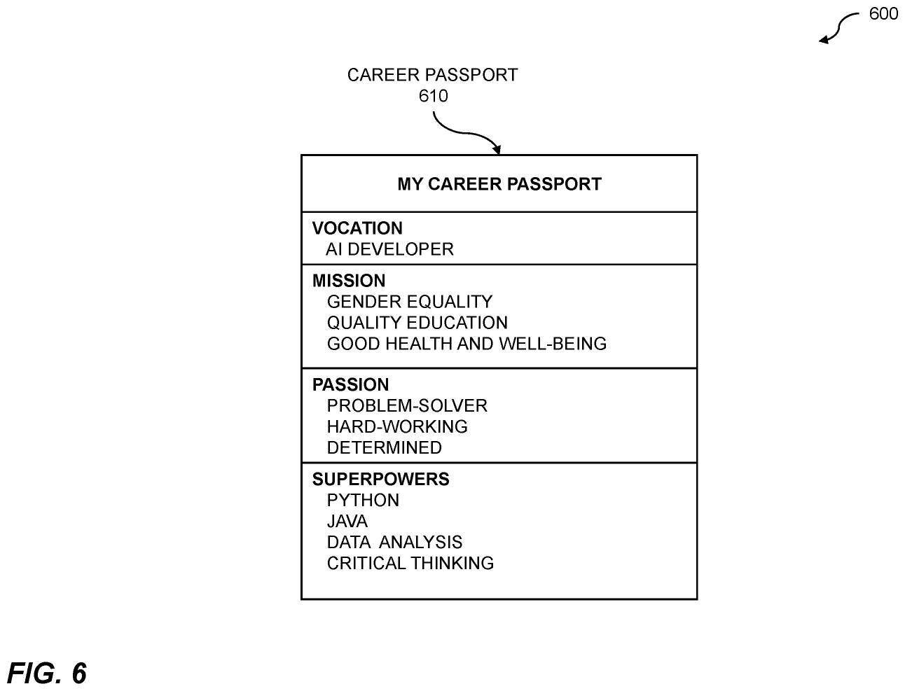

FIG. 6 is an example of a career passport created on the digital platform. In embodiments, a user can access a digital platform that can enable and promote the enhancement of career skills. A chatbot that is included in the digital platform can be initiated by a user action on the digital platform. The chatbot uses a neural network, included in the digital platform machine learning model, that allows human-like interactions with users. After a user accesses the digital platform, a machine learning model can generate a discovery question to solicit career information from a user. In embodiments, the discovery question relates to the personality, technical skills, preferences, or career aspirations of the user. The chatbot discovery question and the response from the user are communicated using natural language processing (NLP). Natural language processing is a form of artificial intelligence (AI) that uses machine learning to process and interpret text and data. The chatbot assistant allows the user to carry on a more human interaction, with the chatbot, that improves over time.

In embodiments, the user response to the discovery question can be processed by the machine learning model within the digital platform. Based on the user response to the discovery question, additional discovery questions generated by the machine learning model can be posed to the user via the chatbot. The additional discovery questions can relate to the personality, technical skills, preferences, or career aspirations of the user. The additional discovery questions can include images related to career paths and related skills. Each user response to additional discovery questions can be recorded, processed, and used to generate additional discovery questions. The entire set of user responses can be used to develop a profile of the user, including skills, career interests and aspirations, education, experience, etc., leading to the development of a career passport 610.

The example 600 includes a career passport 610. In embodiments, the machine learning model generates a recommended career path and one or more related skills based on user responses to discovery questions. The career path and related skills recommendations are based on models of career paths and related skills previously learned by the machine learning model. User responses are compared to learned career path models and the best fitting paths are presented to the user, along with skills related to the career path. The recommended career path, related skills, and additional information supplied by the user are combined to form the career passport 610. The career passport includes information on vocation, mission, and passions of the user based on their responses to discovery questions. It can be used to summarize the user's direction, focus, and career goals; connect with other users with similar interests; and inform future improvement actions. The career passport can include images selected by the user depicting the career path and related skills. In the career passport example 610, the recommended career path is titled “VOCATION” and the career path is AI DEVELOPER. In the example, an image of a robotics engineer working on a mechanical hand can be displayed. The MISSION section reflects the user responses to discovery questions related to career focus, underlying motivations, and long-term aspirations, such as “GENDER EQUALITY, QUALITY EDUCATION, and GOOD HEALTH AND WELL-BEING”. The PASSION section reflects the user's view of their personal approach to work and life in general. The SUPERPOWERS section shows skills that the user already possesses in some measure. The skills listed are related to the VOCATION career path listed above. Images related to the skills can also be displayed alongside the SUPERPOWERS skill list. For example, an image of an analyst working on a problem on an electronic whiteboard or presenting a solution to a group of humans and robots might be included. In some embodiments, some of the skills listed may be selected for improvement actions by the machine learning model to improve performance in areas viewed as deficient.

As mentioned above and throughout, in some embodiments, the development of the career passport can be linked to a metaverse environment that can be accessed by users and others to interact with one another. Comments made by participants can be used by the machine learning engine to develop and refine the career passport. In some embodiments, the user can be connected to friends, peers, mentors, or employers using the digital platform, based on the career passport. The career passport can also be included in a recruiter database.

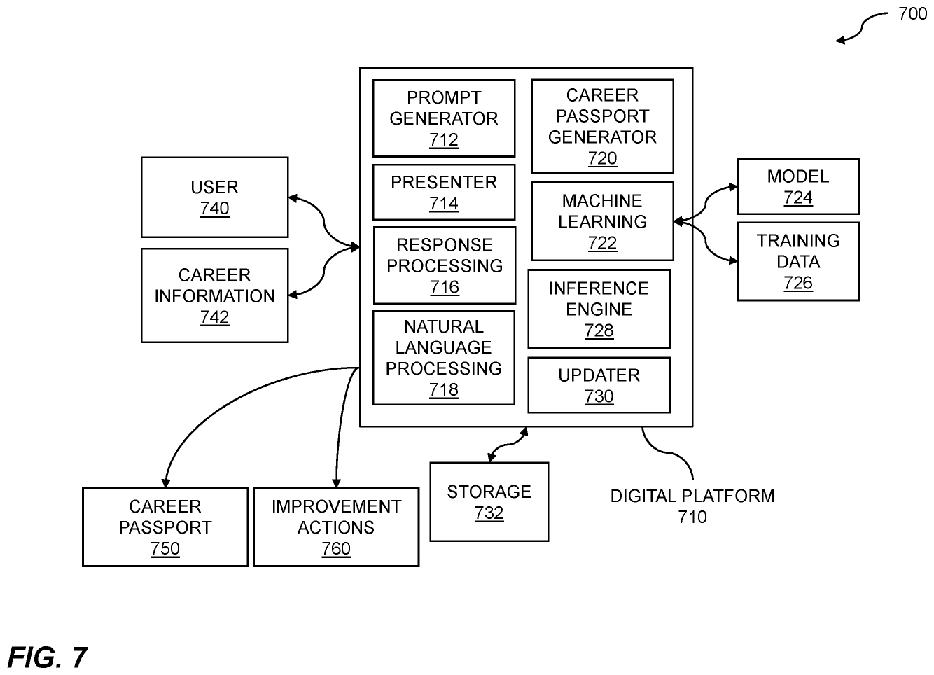

FIG. 7 is a block diagram of a digital platform. The digital platform enables enhancement of one or more career skills and includes an onboarding chatbot. The onboarding chatbot generates a discovery question that solicits career information from a user. The career information from the user is processed using a machine learning model and is used to generate one or more additional discovery questions for the user. The processed career information is used to develop a recommended career path and one or more related skills, which together comprise a career passport. The block diagram 700 includes a digital platform 710 that enables enhancement of one or more career skills. A digital platform is a group of computer-based applications that work together to form a virtual work and communications environment for users. In embodiments, the digital platform can include a prompt generator 712, a presenter 714 in the form of a chatbot, a response processing engine 716 that receives input from a user 740 and other digital platform participants, a natural language processing engine 718, a career passport generator 720, a machine-learning engine 722 to perform tasks based on user 740 data, one or more neural network models 724, training data 726, an inference engine 728, an updater 730, APIs, and tools that allow the digital platform to interact with other software. The digital platform can be presented to users with HTML or other browser-friendly languages. The digital platform can be accessed using a mobile device, pad, tablet, laptop computer, or desktop computer. In some embodiments, a separate application can be used to access a digital platform. In some embodiments, a user can access a digital platform using a connection to a metaverse environment. A metaverse is a shared, collective virtual environment that people access via the Internet. The metaverse environment employs virtual reality and avatars to create a sense of virtual presence within the environment. The metaverse environment can include virtual twins of objects, people, spaces, environments, and so on. Users can interact with computer-generated environments, objects, and other users' avatars within the metaverse environment. An avatar is a graphical representation of a user within a metaverse virtual environment. In embodiments, a metaverse environment can be accessed by digital platform users, employers, friends, peers, mentors, and recruiters to interact with one another. Conversations between participants can be captured and processed by the natural language processing (NLP) engine 718 and machine learning engine 722. Questions and comments made by participants can be used to develop and refine discovery questions and to interpret responses from users.

The block diagram 700 includes a user 740. In embodiments, the user 740 interacts with the digital platform 710 to enhance one or more career skills. The user interaction with the digital platform is performed through a chatbot that acts as a presenter 714 of questions, comments, and other verbal interactions generated by the digital platform 710. A chatbot is an artificial intelligence (AI) driven messaging application that simulates human conversation through voice commands, text chats, or both. In embodiments, the chatbot presenter 714 is connected to the prompt generator 712 and response processing 716 in order to send questions and other forms of verbal prompts to the user and collect responses from the user to be processed. All of the verbal interactions between the user and the digital platform are processed using the natural language processing 718 engine. Natural language processing is a form of artificial intelligence (AI) that uses machine learning to process and interpret text and data. There can be multiple stages in NLP, including language recognition; language generation; language understanding to categorize, archive, and analyze text to determine meaning; and in some embodiments, decision-making based on the meaning of the text. In embodiments, the chatbot presenter 714 linked to the NLP machine learning engine 718 is a conversational chatbot assistant. Conversational AI chatbot assistants are linked to the NLP 718 to understand a wide range of ways in which a user can respond to a question. They learn from each user interaction and can be taught to understand spelling mistakes, shortened words, and acronyms. Historical data can be easily bootstrapped to the NLP machine learning engine so that it learns more quickly. The conversational AI chatbot presenter 714 allows the user 740 to carry on a more human interaction, with the chatbot, that improves over time. In some embodiments, the chatbot NLP can include a virtual drop-down system, showing the user possible response options to discovery questions, such as “coding”, “teaching”, and “reading”.

The block diagram 700 includes a machine learning engine 722. In embodiments, the machine learning engine 722 generates, updates, and uses models 724 of career paths, skills related to careers, and training data 726 to take in career information 742 provided by the user 740, process the career information 742, and make recommendations regarding career paths, related skills, and improvement actions 760 that are designed to enhance the skills related to the user's desired career path. The machine learning engine 722 is implemented using a neural network design that allows human-like interactions with users. A neural network is a form of AI that mimics the human nervous system. Algorithms in a neural network can be used to recognize patterns and correlations in raw data such as verbal or text input, can cluster and classify it, and over time can learn and improve in its responses to new data input. As it processes verbal data, the machine learning engine 722 uses the inference engine 728 to apply logical rule algorithms to the data and deduce new information. For instance, the term “coder” equals the term “programmer” or “developer”. As the machine learning engine 722 takes in more verbal data and applies inference engine 728 logic, the term “developer” can take on multiple equivalents, including “builder” or “designer”, and so on. The additional terms and equivalents can be forwarded to the updater 730, placed into storage 732 and used to expand the logical rules referenced by the inference engine 728. Additional terms used in combination with the primary term such as “developer” can be used to determine which equivalent term is the most accurate. The machine learning engine 722 in combination with the inference engine 728 learns as it interacts with users, expanding its vocabulary and accuracy in responding to users as it goes.

The block diagram 700 includes career information 742 provided by the user 740. In embodiments, the machine learning engine 722 uses the prompt generator 712 to forward a discovery question to the user 740 in order to solicit career information 742. The chatbot presenter 714 poses the discovery question to the user and processes the response 716.

The discovery question relates to the personality, technical skills, preferences, or career aspirations of the user, for example, “What 3 things would you rather be doing?” The chatbot discovery question and the response from the user are communicated using natural language processing (NLP) 718. The user 740 response to the discovery question can be processed by the response processing engine 716 working with the machine learning engine 722. The career information processing can include comparing the user response to those of other users and to categories of responses linked to particular skills, career paths, and goals that are part of the machine learning model. Based on the user response to the discovery question, additional discovery questions can be posed to the user 740 via the chatbot presenter 714. The additional discovery questions can relate to the personality, technical skills, preferences, or career aspirations of the user. In some embodiments, the machine learning neural network can select images that illustrate and promote career paths and related skills based on the user's responses. Each user response to additional discovery questions can be recorded and used to generate additional discovery questions and to develop a profile of the user, including skills, career interests and aspirations, education, experience, etc., leading to the development of a career passport 750.

The block diagram 700 includes a career passport generator 720. The career passport 750 includes information on vocation, mission, and passions of the user based on their responses to discovery questions. It can be used to summarize the user's direction, focus, and career goals; connect with other users with similar interests; and inform future improvement actions. As mentioned above and throughout, the development of the career passport can be linked to a metaverse environment that can be accessed by users and others to interact with one another. Comments made by participants can be used by the machine learning engine 722 to develop and refine the career passport 750. Once the career passport is generated, it is presented 714 to the user 740. In some embodiments, the user 740 can be connected to friends, peers, mentors, or employers using the digital platform 710, based on the career passport 750. The career passport 750 can also be included in a recruiter database and stored for later reference or revision.

The block diagram 700 includes improvement actions 760 which are recommendations and goals for the user 740 generated by the machine learning engine 722 intended to enhance the skills related to a career path included in the user's career passport 750. In embodiments, the related skills included in the career passport 750 are based on machine learning models 724 of career paths and skills required to succeed in the career paths. The recommended actions are based on one or more related skills that are current deficiencies for the user 740. For example, the digital platform chatbot might say, “I'd recommend coding for 20 minutes. Sound good?” to a user that wants to become an application developer. In embodiments, the recommendations further involve establishing a goal for the user, wherein the goal enhances the one or more related skills. The goal can be acted upon by the user 740 and completed goals can be recorded and stored by the digital platform.

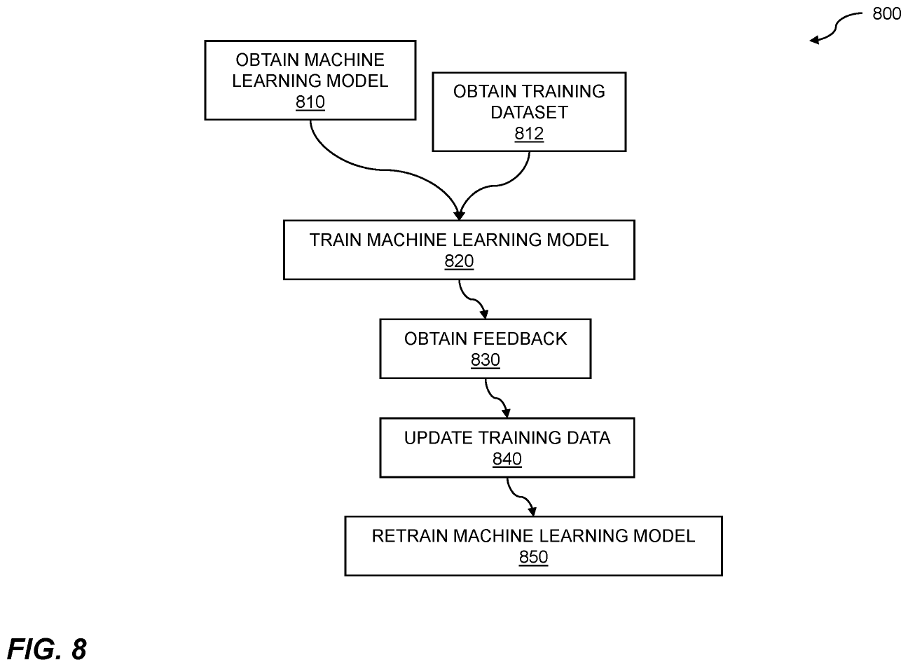

FIG. 8 is a flow diagram for machine learning. The machine learning enables enhancement of one or more career skills and includes an onboarding chatbot. The onboarding chatbot generates a discovery question that solicits career information from a user. The career information from the user is processed using a machine learning model and is used to generate one or more additional discovery questions for the user. The processed career information is used to develop a recommended career path and one or more related skills, which together comprise a career passport. The flow 800 includes obtaining a machine learning model 810 and a training dataset 812. In embodiments, program code for neural network machine learning models is available on the Internet from many sources. Classes and online software developers are also available to build a neural network model based on specific parameters. AI neural network developers can also be employed in-house to allow more immediate and direct control of the model building process. Career training datasets 812 can also be obtained from multiple sources. For example, one online database contains information on thousands of data scientist job postings across the USA. Another contains all job postings and related skills for the greater New York City area. In some cases, the career datasets are offered free of charge; others are sold.

The flow 800 includes training the machine learning model 820. In embodiments, after the machine learning model and training dataset are obtained, the machine learning model must be trained. In embodiments, a neural network is made up of a set of mathematical functions known as neurons that are combined so that the output from one neuron becomes the input for other neurons. The neurons can be stacked in layers so that each layer feeds multiple neurons of the next layer. Each neuron can take multiple inputs, and for each input value the neuron function can assign another number called a weight vector. The weight vector can be altered for each neuron in order to give it a unique value. At the beginning of the training process, the weights for each neuron are assigned randomly. As data from the training dataset is fed into the neural network and processed, the resulting output values can be compared to a set of desired values. In some instances, the neural network output values can be subtracted from the desired values and the results squared. The squared result is called a loss function. The goal of training the machine learning model is to minimize the loss function as successive batches of training data are fed into the neural network. This is done by varying the weight values of the neurons using one or more optimization algorithms, such as gradient descent, mini-batch, stochastic gradient descent, root mean square prop (RMSProp), etc. The result is that career information from users fed into the machine learning model can be matched with career paths and related skills more and more closely as the neural network is optimized and stores increasing amounts of career and skill data.

The flow 800 includes obtaining feedback 830 related to the career paths and related skills. In embodiments, as users, employers, mentors, peers, friends, and recruiters interact with one another on the digital platform, and with the machine learning model, additional relationships between careers and skills may be discovered. Some relationships may become obsolete or less important based on input from users with particular careers or employers. For example, AI developers can comment that C++ or Python is more often required as a programming language than LISP or Java. As more users associated with AI development make similar comments, the skills related to AI developer or programmer career paths within the training data 840 can be updated to reflect the program language preference. The updated training data 840 can be used to retrain the machine learning model 850 so that users with career information that results in a recommendation of AI developer as a career path also receive a recommendation to learn C++ and Python. The subsequent goals generated by the machine learning model can be designed to help the user learn these programming languages. Additional career data can also be collected from public domain and commercial sources to be fed into the training dataset. Thus, the machine learning model continues to expand and improve its ability to match career paths to user information as it receives additional training data.

Various steps in the flow 800 may be changed in order, repeated, omitted, or the like without departing from the disclosed concepts. Various embodiments of the flow 800 can be included in a computer program product embodied in a non-transitory computer readable medium that includes code executable by one or more processors.

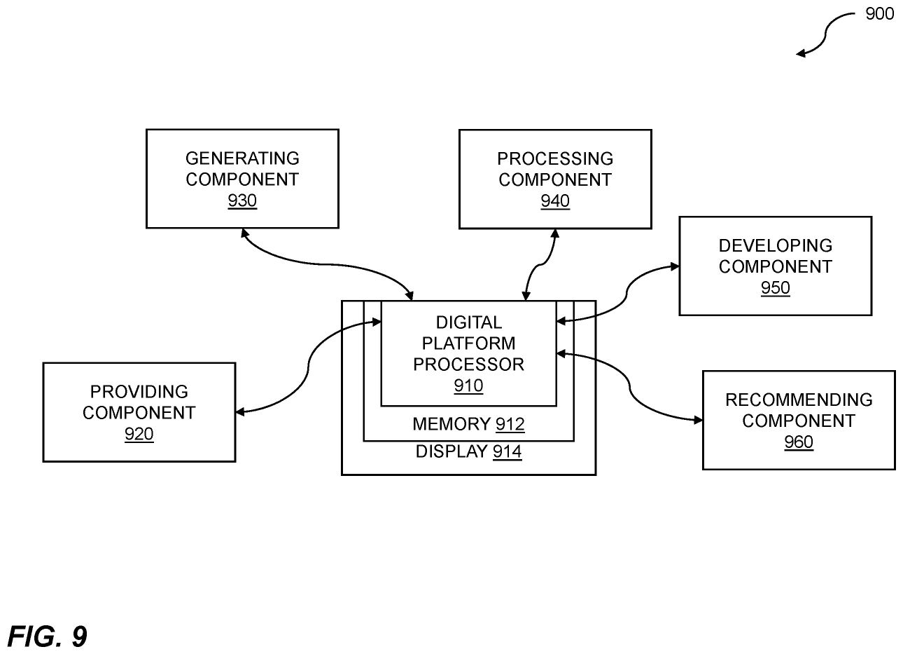

FIG. 9 is a system diagram of AI-driven skills enhancement. The system enables enhancement of one or more career skills and includes an onboarding chatbot. The onboarding chatbot generates a discovery question that solicits career information from a user. The career information from the user is processed using a machine learning model and is used to generate one or more additional discovery questions for the user. The processed career information is used to develop a recommended career path and one or more related skills, which together comprise a career passport. The system 900 can include one or more processors 910 coupled to a memory 912 which stores instructions. The system 900 can include a display 914 coupled to the one or more processors 910 for displaying data, video streams, videos, intermediate steps, instructions, and so on. In embodiments, one or more processors 910 are coupled to the memory 912 where the one or more processors, when executing the instructions which are stored, are configured to: provide a digital platform that enables enhancement of one or more career skills, wherein the digital platform includes an onboarding chatbot; generate a discovery question, by the onboarding chatbot, wherein the discovery question solicits career information from a user; process the career information from the user, wherein the processing generates one or more further discovery questions for the user, and wherein the processing is based on a machine learning model running on the digital platform; develop for the user, using one or more processors, a recommended career path and one or more related skills, wherein the developing is based on the processing of the career information; and recommend career-related improvement actions to the user, by the machine learning model, to enhance the one or more related skills.

The system 900 includes a providing component 920. The providing component 920 can include functions and instructions for providing a digital platform that enables enhancement of one or more career skills, wherein the digital platform includes an onboarding chatbot. The chatbot can be initiated by a user action on the digital platform, such as signing on or setting up a user ID. A chatbot is an artificial intelligence (AI) driven messaging application that simulates human conversation through voice commands, text chats, or both. In embodiments, the chatbot uses a machine learning neural network included in the digital platform that allows human-like interactions with users. A neural network is a form of AI that mimics the human nervous system. Algorithms in a neural network can be used to recognize patterns and correlations in raw data such as verbal or text input, can cluster and classify it, and over time can learn and improve in its responses to new data input. The chatbot program learns as it interacts with users, expanding its vocabulary and accuracy in responding to users as it goes.

The system 900 includes a generating component 930. The generating component 930 can include functions and instructions for generating a discovery question, by an onboarding chatbot, wherein the discovery question solicits career information from a user. The discovery question relates to the personality, technical skills, preferences, or career aspirations of the user. The discovery question and the information from the user can be communicated using natural language processing (NLP). Natural language processing is a form of artificial intelligence (AI) that uses machine learning to process and interpret text and data. There can be multiple stages in NLP, including language recognition; language generation; language understanding to categorize, archive, and analyze text to determine meaning; and in some embodiments, decision-making based on the meaning of the text. In embodiments, the chatbot linked to the NLP machine learning engine is a conversational chatbot. Conversational AI chatbots are linked to the machine learning neural network to understand a wide range of ways in which a user can respond to a question. They learn from each user interaction and can be taught to understand spelling mistakes, shortened words, and acronyms. Historical data can be easily bootstrapped to the NLP machine learning engine so that it learns more quickly. The conversational AI chatbot allows the user to carry on a more human interaction, with the chatbot, that improves over time. The NLP can include a virtual drop-down system to suggest responses to the user.

The generating component 930 can include a metaverse environment, wherein the metaverse environment employs virtual reality. A metaverse is a shared, collective virtual environment that people access via the Internet. The metaverse environment employs virtual reality and avatars to create a sense of virtual presence within the environment. The metaverse environment can include virtual twins of objects, people, spaces, environments, and so on. Users can interact with computer-generated environments, objects, and other users' avatars within the metaverse environment. An avatar is a graphical representation of a user within the metaverse virtual environment. In embodiments, a metaverse environment can be accessed by the digital platform users, employers, friends, peers, mentors, and recruiters to interact with one another. Conversations between participants can be captured and analyzed by the NLP machine learning engine. Questions and comments made by participants can be used to develop and refine discovery questions and to interpret responses from users. In embodiments, the metaverse environment can be used across the various components of the digital platform, including the processing component 940, the developing component 950, and the recommending component 960, as well as the generating component 930.

The system 900 includes a processing component 940. The processing component 940 can include functions and instructions for processing the career information from the user, wherein the processing generates one or more further discovery questions for the user, and wherein the processing is based on a machine learning model running on the digital platform. In embodiments, the user response to the discovery question can be processed by the machine learning model within the digital platform. The career information processing can include comparing the user response to those of other users and to categories of responses linked to particular skills, career paths, and goals that are part of the machine learning model. Based on the user response to the discovery question, additional discovery questions can be posed to the user via the chatbot. The additional discovery questions can relate to the personality, technical skills, preferences, or career aspirations of the user. In embodiments, each user response to additional discovery questions can be recorded and used to generate additional discovery questions and to develop a profile of the user, including skills, career interests and aspirations, education, experience, etc., leading to the development of a career passport.

In embodiments, the processing the career information includes selecting images of various careers and skills for the user. The selecting of the images is accomplished by the machine learning model based on user responses to discovery questions. The images can be selected from a library of images that can be analyzed by the machine learning engine. A machine learning network can be taught to identify objects of interest that appear in images and recognize which category of career or skill they belong to. Training data in the form of video images, scanned pictures, and photographs can be fed into a machine learning algorithm. The training data can be used to create an image recognition model. As the machine learning model is trained with multiple images of career paths and related skills, the image recognition model is refined to identify specific categories and classes. Once the image recognition model is built, it can be tested and refined with additional images of various careers and skills. The result is a growing set of images that can be selected and displayed for the user based on responses for discovery questions. In embodiments, the images stimulate interest in the various career paths and related skills for the user. The machine learning model can be implemented using a neural network. A neural network is a form of AI that mimics the human nervous system. Algorithms in a neural network can be used to recognize patterns and correlations in raw data such as verbal or text input, can cluster and classify it, and over time can learn and improve in its responses to new data input. Other machine learning structures may be suitable to support career passport development.

The system 900 includes a developing component 950. The developing component 950 can include functions and instructions for developing for the user, using one or more processors 910, a recommended career path and one or more related skills, wherein the developing is based on the processing of the career information. The recommended career path and the one or more related skills comprise a career passport. The career passport includes information on vocation, mission, and passions of the user based on their responses to discovery questions. It can be used to summarize the user's direction, focus, and career goals; connect with other users with similar interests; and inform future improvement actions. The career passport can include images of recommended career paths and related skills. The career passport can be presented to the user on the digital platform. The user can be connected to friends, peers, mentors, or employers based on the career passport. The career passport can also be included in a recruiter database.

The system 900 includes a recommending component 960. The recommending component 960 can include functions and instructions for recommending career-related improvement actions to the user, by the machine learning model, to enhance the one or more related skills. The one or more related skills can be current deficiencies of the user. The recommending component 960 further comprises establishing a goal for the user, wherein the goal enhances the one or more related skills. The goal can be a part of a digital vision board built and displayed on the digital platform. The recommending component 960 can include reminding the user to complete the goal using one or more alerts. The one or more alerts can include an alarm, countdown timer, or email based on a timeline associated with the one or more related skills. The recommending component 960 can include the ability for the user to change the alerts. The recommending component 960 can further include recording a history of completed goals. A streak of completed goals related to the enhancing of the one or more related skills can be tracked. The information on the streak can be displayed in an application running on a mobile device and shared with others on a social network.

The recommending component 960 can include updating training data for the machine learning module, wherein the training includes learning models for various careers. The machine learning model can be retrained based on the updated training data.

The system 900 can include a computer program product embodied in a non-transitory computer readable medium for career skills enhancement, the computer program product comprising code which causes one or more processors to perform operations of: providing a digital platform that enables enhancement of one or more career skills, wherein the digital platform includes an onboarding chatbot; generating a discovery question, by the onboarding chatbot, wherein the discovery question solicits career information from a user; processing the career information from the user, wherein the processing generates one or more further discovery questions for the user, and wherein the processing is based on a machine learning model running on the digital platform; developing for the user, using one or more processors, a recommended career path and one or more related skills, wherein the developing is based on the processing of the career information; and recommending career-related improvement actions to the user, by the machine learning model, to enhance the one or more related skills.

Each of the above methods may be executed on one or more processors on one or more computer systems. Embodiments may include various forms of distributed computing, client/server computing, and cloud-based computing. Further, it will be understood that the depicted steps or boxes contained in this disclosure's flow charts are solely illustrative and explanatory. The steps may be modified, omitted, repeated, or re-ordered without departing from the scope of this disclosure. Further, each step may contain one or more sub-steps. While the foregoing drawings and description set forth functional aspects of the disclosed systems, no particular implementation or arrangement of software and/or hardware should be inferred from these descriptions unless explicitly stated or otherwise clear from the context. All such arrangements of software and/or hardware are intended to fall within the scope of this disclosure.

The block diagrams, infographics, and flowchart illustrations depict methods, apparatus, systems, and computer program products. The elements and combinations of elements in the block diagrams, infographics, and flow diagrams show functions, steps, or groups of steps of the methods, apparatus, systems, computer program products and/or computer-implemented methods. Any and all such functions—generally referred to herein as a “circuit,” “module,” or “system”—maybe implemented by computer program instructions, by special-purpose hardware-based computer systems, by combinations of special purpose hardware and computer instructions, by combinations of general-purpose hardware and computer instructions, and so on.

A programmable apparatus which executes any of the above-mentioned computer program products or computer-implemented methods may include one or more microprocessors, microcontrollers, embedded microcontrollers, programmable digital signal processors, programmable devices, programmable gate arrays, programmable array logic, memory devices, application specific integrated circuits, or the like. Each may be suitably employed or configured to process computer program instructions, execute computer logic, store computer data, and so on.

It will be understood that a computer may include a computer program product from a computer-readable storage medium and that this medium may be internal or external, removable and replaceable, or fixed. In addition, a computer may include a Basic Input/Output System (BIOS), firmware, an operating system, a database, or the like that may include, interface with, or support the software and hardware described herein.

Embodiments of the present invention are limited to neither conventional computer applications nor the programmable apparatus that run them. To illustrate: the embodiments of the presently claimed invention could include an optical computer, quantum computer, analog computer, or the like. A computer program may be loaded onto a computer to produce a particular machine that may perform any and all of the depicted functions. This particular machine provides a means for carrying out any and all of the depicted functions.

Any combination of one or more computer readable media may be utilized including but not limited to: a non-transitory computer readable medium for storage; an electronic, magnetic, optical, electromagnetic, infrared, or semiconductor computer readable storage medium or any suitable combination of the foregoing; a portable computer diskette; a hard disk; a random access memory (RAM); a read-only memory (ROM); an erasable programmable read-only memory (EPROM, Flash, MRAM, FeRAM, or phase change memory); an optical fiber; a portable compact disc; an optical storage device; a magnetic storage device; or any suitable combination of the foregoing. In the context of this document, a computer readable storage medium may be any tangible medium that can contain or store a program for use by or in connection with an instruction execution system, apparatus, or device.

It will be appreciated that computer program instructions may include computer executable code. A variety of languages for expressing computer program instructions may include without limitation C, C++, Java, JavaScript™, ActionScript™, assembly language, Lisp, Perl, Tcl, Python, Ruby, hardware description languages, database programming languages, functional programming languages, imperative programming languages, and so on. In embodiments, computer program instructions may be stored, compiled, or interpreted to run on a computer, a programmable data processing apparatus, a heterogeneous combination of processors or processor architectures, and so on. Without limitation, embodiments of the present invention may take the form of web-based computer software, which includes client/server software, software-as-a-service, peer-to-peer software, or the like.

In embodiments, a computer may enable execution of computer program instructions including multiple programs or threads. The multiple programs or threads may be processed approximately simultaneously to enhance utilization of the processor and to facilitate substantially simultaneous functions. By way of implementation, any and all methods, program codes, program instructions, and the like described herein may be implemented in one or more threads which may in turn spawn other threads, which may themselves have priorities associated with them. In some embodiments, a computer may process these threads based on priority or other order.

Unless explicitly stated or otherwise clear from the context, the verbs “execute” and “process” maybe used interchangeably to indicate execute, process, interpret, compile, assemble, link, load, or a combination of the foregoing. Therefore, embodiments that execute or process computer program instructions, computer-executable code, or the like may act upon the instructions or code in any and all of the ways described. Further, the method steps shown are intended to include any suitable method of causing one or more parties or entities to perform the steps. The parties performing a step, or portion of a step, need not be located within a particular geographic location or country boundary. For instance, if an entity located within the United States causes a method step, or portion thereof, to be performed outside of the United States, then the method is considered to be performed in the United States by virtue of the causal entity.

While the invention has been disclosed in connection with preferred embodiments shown and described in detail, various modifications and improvements thereon will become apparent to those skilled in the art. Accordingly, the foregoing examples should not limit the spirit and scope of the present invention; rather it should be understood in the broadest sense allowable by law.

What is claimed is:

1. A computer-implemented method for career skills enhancement comprising:
providing a digital platform that enables enhancement of one or more career skills, wherein the digital platform includes an onboarding chatbot;
generating a discovery question, by the onboarding chatbot, wherein the discovery question solicits career information from a user;
processing the career information from the user, wherein the processing generates one or more further discovery questions for the user, and wherein the processing is based on a machine learning model running on the digital platform;
developing for the user, using one or more processors, a recommended career path and one or more related skills, wherein the developing is based on the processing of the career information; and
recommending career-related improvement actions to the user, by the machine learning model, to enhance the one or more related skills.

2. The method of claim 1 wherein the recommended career path and the one or more related skills comprise a career passport.

3. The method of claim 2 wherein the career passport includes information on vocation, mission, and passions of the user.

4. The method of claim 3 wherein the recommending further comprises establishing a goal, for the user, wherein the goal enhances the one or more related skills.

5. The method of claim 4 further comprising reminding the user to complete the goal using one or more alerts.

6. The method of claim 5 wherein the one or more alerts include an alarm or countdown timer based on a timeline associated with the one or more related skills.

7. The method of claim 6 wherein the reminding includes an ability for the user to change the one or more alerts.

8. The method of claim 4 further comprising tracking a streak of completed items related to enhancing of the one or more related skills.

9. The method of claim 8 further comprising sharing the streak of completed items with a social network.

10. The method of claim 8 further comprising displaying information on the streak in an application running on a mobile device.

11. The method of claim 4 further comprising recording a history of completed items.

12. The method of claim 4 further comprising representing the goal as part of a digital vision board.

13. The method of claim 2 further comprising connecting the user to friends, peers, mentors, or employers, wherein the connecting is based on the career passport.

14. The method of claim 13 wherein the career passport is included in a recruiter database.

15. The method of claim 2 further comprising presenting the career passport to the user.

16. The method of claim 1 wherein the discovery question and information from the user are communicated using natural language processing (NLP).

17. The method of claim 16 wherein the discovery question relates to personality, technical skills, preferences, or career aspirations of the user.

18. The method of claim 1 wherein the one or more related skills are current deficiencies of the user.

19. The method of claim 1 further comprising updating training data for the machine learning model.

20. The method of claim 19 wherein training includes learning models for various careers.

21. The method of claim 19 further comprising retraining the machine learning model, based on the training data that was updated.

22. The method of claim 1 wherein the onboarding chatbot is initiated by a user action on the digital platform.

23. The method of claim 1 wherein the generating, the processing, the developing, and the recommending occur using a metaverse environment.

24. The method of claim 1 wherein the processing the career information includes selecting images of various careers and skills for the user.

25. A computer program product embodied in a non-transitory computer readable medium for career skills enhancement, the computer program product comprising code which causes one or more processors to perform operations of:
providing a digital platform that enables enhancement of one or more career skills, wherein the digital platform includes an onboarding chatbot;
generating a discovery question, by the onboarding chatbot, wherein the discovery question solicits career information from a user;
processing the career information from the user, wherein the processing generates one or more further discovery questions for the user, and wherein the processing is based on a machine learning model running on the digital platform;
developing for the user a recommended career path and one or more related skills, wherein the developing is based on the processing of the career information; and
recommending career-related improvement actions to the user, by the machine learning model, to enhance the one or more related skills.

26. A computer system for career skills enhancement, comprising:
a memory which stores instructions;
one or more processors coupled to the memory wherein the one or more processors, when executing the instructions which are stored, are configured to:
provide a digital platform that enables enhancement of one or more career skills, wherein the digital platform includes an onboarding chatbot;
generate a discovery question, by the onboarding chatbot, wherein the discovery question solicits career information from a user;
process the career information from the user, wherein the processing generates one or more further discovery questions for the user, and wherein the processing is based on a machine learning model running on the digital platform;
develop for the user a recommended career path and one or more related skills, wherein developing is based on the processing of the career information; and
recommend career-related improvement actions to the user, by the machine learning model, to enhance the one or more related skills.
